(19) United States
(12) Patent Application Publication
(10) Pub. No.: US 2005/0219778 A1
(43) Pub. Date: Oct. 6, 2005

(54) Semiconductor device

(76) Inventor: Toshihiko Shigenari, Soraku-gun (JP)

Correspondence Address: HARNESS, DICKEY & PIERCE, P.L.C., P.O. BOX 8910, RESTON, VA, 20195, US

(21) Appl. No.: 11/093,046

(22) Filed: Mar. 30, 2005

(30) Foreign Application Priority Data
Mar. 31, 2004 (JP) 2004-108022

(51) Int. Cl. H02H 9/00

(52) U.S. Cl. 361/56

(57) ABSTRACT

A semiconductor device, comprises: a first circuitry including a transistor; a terminal portion for connecting the first circuitry and a second circuitry to which a predetermined voltage is applied; a plurality of first protection sections connected in series between the terminal portion and a positive power supply; and a plurality of second protection sections connected in series between the terminal portion and a negative power supply.

This Nonprovisional application claims priority under 35 U.S.C. §119(a) on Patent Application No. 2004-108022 filed in Japan on Mar. 31, 2004, the entire contents of which are hereby incorporated by reference.

### BACKGROUND OF THE INVENTION

1. Field of the Invention

The present invention relates to a semiconductor device including a protection circuitry.

2. Description of the Related Art

In a semiconductor device forming a semiconductor integrated circuit, a protection circuitry is connected to an output terminal OUT of an internal circuit in order to protect the inner circuit from a voltage applied from outside to the semiconductor device, or a current which flows into/from a circuit connected to the semiconductor device.

For example, in a MOS LSI, an output terminal portion is usually connected to drains of complementary MOS transistors. Since impedance of the inner circuit is high, the transistors included in the MOS LSI may be undesirably destroyed and may result in an unrecoverable failure due to a surge voltage applied to the output terminal portion when the MOSLSI is stored before the implementation onto a circuit board, or when it is implemented. For increasing withstand voltages of the transistors, a method of extending gate lengths of the transistors may be considered. However, when such a method is used, the area of the semiconductor device has to be increased. Accordingly, this method is not practical.

Thus, a protection circuitry having an electro static discharge (ESD) protecting function is connected to such an output terminal portion (see Japanese Laid-Open Publication Nos. 4-354158 and 3-120751). FIG. 5 shows a semiconductor device 500 including such a protection circuitry.

In the semiconductor device 500, an output circuit 501 and an output terminal portion OUT are connected to each other via a protection resistance R. Between the output terminal portion OUT and a power supply VDD, a pn junction diode D51 is provided. Between the output terminal portion OUT and ground GND, a pn junction diode D52 is provided. Herein, when a positive voltage(positive potential noise) larger than the voltage at the power supply VDD is applied to the output terminal portion OUT, the diode D51 becomes conductive and the positive potential noise is absorbed to the power supply VDD (i.e., discharged). When a negative voltage (negative potential noise) having an absolute value larger than that of the voltage at the ground GND is applied to the output terminal portion OUT, the diode D52 becomes conductive and the negative potential noise is absorbed to the ground GND. In such a way, the diodes D51 and D52 function as a protection circuitry.

FIG. 6 shows a semiconductor device 600 as another example of a semiconductor device including a protection circuitry. An output circuit 601 and an output terminal portion OUT are connected to each other via a protection resistance R. Between the output terminal portion OUT and ground GND, a punch-through device P61 is provided. Between a power supply VDD and the ground GND, a punch-through device P62 is provided. The punch-through devices P61 and P62 function as a protection circuitry.

FIG. 7 shows an equivalent circuit diagram of the punch-through devices P61 and P62. FIG. 8 shows a cross sectional view of the punch-through devices P61 and P62. As shown in FIG. 8, the punch-through devices P61 and P62 include P-substrate 81, P+ region 82, and N+ regions 83 and 84. A gate oxide capacitance Csub is added between a collector region C and a base region B. A P diffusion resistance Rsub is added between the base region B and an emitter region E.

When a positive voltage (positive potential noise) larger than the voltage at the power supply VDD is applied to the output terminal portion OUT, the positive potential noise is applied to a positive pole 85 of the punch-through device P61 and a punch-through phenomenon occurs between the collector region C and the base region B. The positive potential noise reaches a negative pole 86 (GND) of the punch-through device P61, and then is absorbed to the power supply VDD via the punch-through device P62 in a forward bias state. When a negative voltage (negative potential noise) having an absolute value larger than that of the voltage at the ground GND is applied to the output terminal portion OUT, the negative potential noise is absorbed to the ground GND via the punch-through device P61 in a forward bias state.

The semiconductor device may also include an output buffer circuit which is actuated by applying a power supply voltage equal to or higher than the withstand voltage of an inner transistor from outside (see Japanese Laid-Open Publication No. 2000-278112).

In general, in the protection circuitries shown in FIGS. 5 and 6, the relationship between a reverse direction withstand voltage BVceo of the diodes D51 and D52 and the punch-through devices P61 and P62, and the voltage of the power supply VDD has to satisfy the following expression (1).
Power supply voltage≦BVceo (1)

However, in the output buffer circuit which is actuated by applying a power supply voltage equal to or higher than the withstand voltage of the inner transistor (voltage equal to BVceo) from outside, the output terminal portion OUT swings depending upon the external power supply voltage. Thus, when a protection circuitry is provided in such an output buffer circuit, the withstand voltage of the protection circuitry has to be equal to or higher than the external power supply voltage.

### SUMMARY OF THE INVENTION

According to one aspect of the present invention, there is provided a semiconductor device, comprising: a first circuitry including a transistor; a terminal portion for connecting the first circuitry and a second circuitry to which a predetermined voltage is applied; a plurality of first protection sections connected in series between the terminal portion and a positive power supply; and a plurality of second protection sections connected in series between the terminal portion and a negative power supply.

In one embodiment of the present invention, the predetermined voltage is a voltage such that, when it is applied to the transistor, a potential difference between a potential at one end of the transistor and a potential at the other end becomes larger than a withstand voltage of the transistor.

In one embodiment of the present invention, withstand voltages of the plurality of first protection sections and the plurality of second protection sections are equal to or higher than the withstand voltage of the transistor.

In one embodiment of the present invention, the plurality of first protection sections and the plurality of second protection sections are respectively diodes.

In one embodiment of the present invention, the first circuitry is an output buffer circuitry.

In another aspect of the present invention, there is provided a semiconductor device, comprising: a first circuitry including a transistor; a terminal portion for connecting the first circuitry and a second circuitry to which a predetermined voltage is applied; a plurality of first protection sections connected in series between one of a positive power supply and a negative power supply and a voltage application section to which a first voltage is applied; and a plurality of second protection sections connected in series between the voltage application section and the terminal portion.

In one embodiment of the present invention, the voltage application section is the other of the positive power supply and the negative power supply.

In one embodiment of the present invention, the predetermined voltage is a voltage such that, when it is applied to the transistor, a potential difference between a potential at one end of the transistor and a potential at the other end becomes larger than a withstand voltage of the transistor.

In one embodiment of the present invention, withstand voltages of the plurality of first protection sections and the plurality of second protection sections are equal to or higher than the withstand voltage of the transistor.

In one embodiment of the present invention, the plurality of first protection sections and the plurality of second protection sections are respectively punch-through devices.

In one embodiment of the present invention, the first circuitry is an output buffer circuitry.

A semiconductor device according to the present invention includes: a plurality of first protection sections connected in series between a terminal portion and a positive power supply; and a plurality of second protection portions connected in series between the terminal portion and a negative power supply. This characteristic allows a transistor in a circuit to be protected even when a voltage equal to or higher than the withstand voltage of the transistor is applied from outside. Since the plurality of first protection sections are connected in series, and the plurality of second protection sections are also connected in series, the protection sections have a sufficient protection function even when a voltage equal to or higher than the withstand voltage of one protection section is applied to the terminal portion.

Further, a semiconductor device according to the present invention includes: a plurality of first protection sections connected in series between one of a positive power supply and a negative supply and a voltage application section to which a first voltage is applied; and a plurality of second protection sections connected in series between the voltage application section and a terminal portion. This characteristic allows a transistor in a circuit to be protected even when a voltage equal to or higher than the withstand voltage of the transistor is applied from outside. Since the plurality of first protection sections are connected in series, and the plurality of second protection sections are also connected in series, the protection sections have a sufficient protection function even when a voltage equal to or higher than the withstand voltage of one protection section is applied to the terminal portion.

Thus, the invention described herein makes possible the advantages of providing a semiconductor device including a protection circuitry which can protect a transistor even when a voltage equal to or higher than a withstand voltage of the transistor in the circuit is applied from outside.

These and other advantages of the present invention will become apparent to those skilled in the art upon reading and understanding the following detailed description with reference to the accompanying figures.

### BRIEF DESCRIPTION OF THE DRAWINGS

FIG. 1 shows a semiconductor device according to Embodiment 1 of the present invention.

FIG. 2 shows an output buffer circuitry in Embodiment 1 of the present invention.

FIG. 3A shows a voltage of a signal to be input to the input terminal portion IN.

FIG. 3B shows a voltage of a signal to be output from the output terminal portion OUT.

FIG. 4 shows a semiconductor device according to Embodiment 2 of the present invention.

FIG. 5 shows a semiconductor device including a protection circuitry.

FIG. 6 shows another example of a semiconductor device including a protection circuitry.

FIG. 7 shows an equivalent circuit diagram of punch-through devices.

FIG. 8 shows a cross sectional view of the punch-through devices.

### DESCRIPTION OF THE PREFERRED EMBODIMENTS

### Embodiment 1

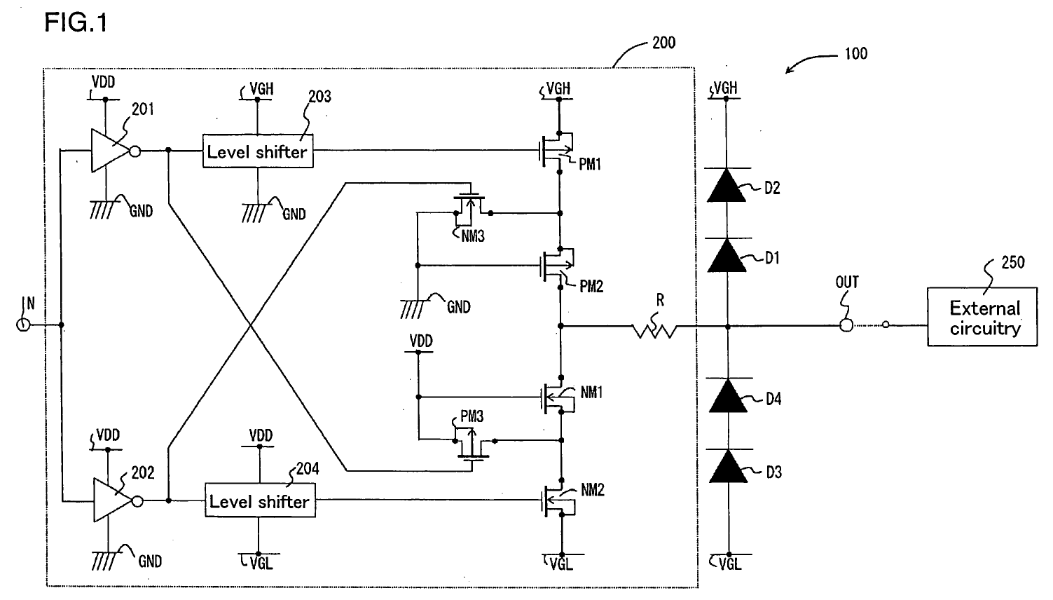

FIG. 1 shows a semiconductor device 100 according to Embodiment 1 of the present invention.

The semiconductor device 100 includes an output buffer circuitry 200, an input terminal portion IN, an output terminal portion OUT, and a plurality of diodes D1 through D4.

The output buffer circuitry 200 is connected to an external circuitry 250 via a protection resistance R and the output terminal portion OUT. The diodes D1 and D2 are connected in series and in a forward direction between the output terminal portion OUT and a positive power supply VGH. The diodes D3 and D4 are connected in series and in a forward direction between a negative power supply VGL and the output terminal portion OUT.

The diodes D1 through D4 are, for example, pn junction diodes, and function as protection sections for protecting transistors from a positive potential noise and a negative potential noise. In this embodiment, a plurality of protection sections are collectively referred to as a protection circuitry.

The external circuitry 250 is actuated by applying a predetermined voltage. In this example, the predetermined voltage is a voltage such that, when the predetermined voltage is applied to a transistor included in the output buffer circuitry 200 (for example, a transistor NM1 or PM2), a potential difference between the potential at one end (for example, a source electrode) of the transistor and the potential at the other end (for example, a drain electrode) becomes higher than the withstand voltage of the transistor. As used herein, the voltage equal to or higher than the withstand voltage of the transistor means a voltage such that, when the voltage is applied to the transistor, a potential difference between the one end and the other end of the transistor becomes higher than the withstand voltage of the transistor.

An anode of the diode D1 is connected to the output terminal portion OUT. A cathode of the diode D1 is connected to an anode of the diode D2. A cathode of the diode D2 is connected to the positive power supply VGH. An anode of the diode D3 is connected to the negative power supply VGL. A cathode of the diode D3 is connected to an anode of the diode D4. A cathode of the diode D4 is connected to the output terminal portion OUT.

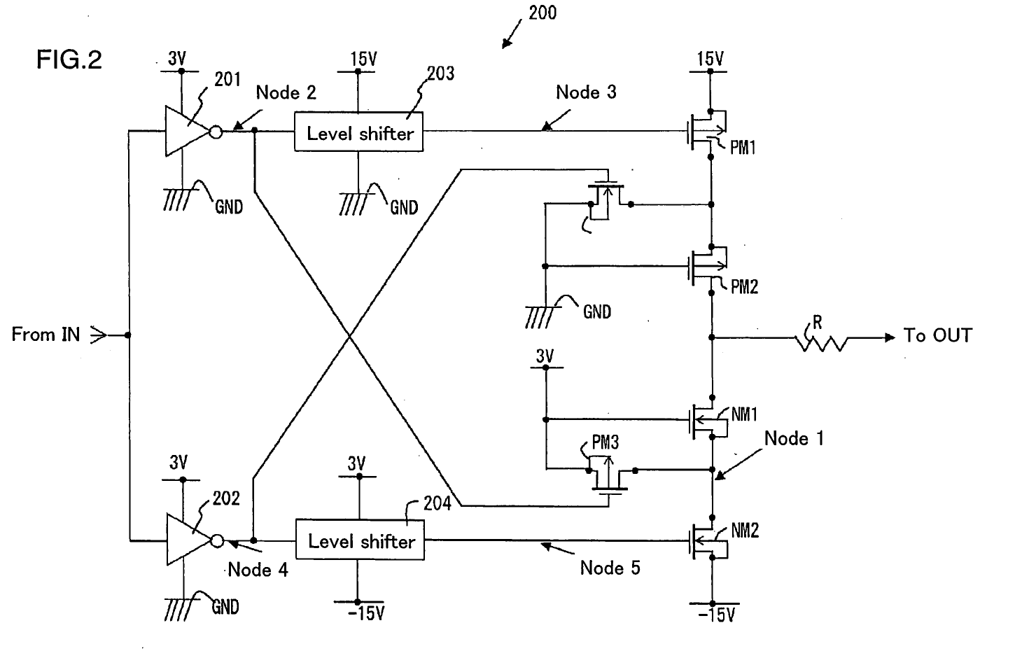

FIG. 2 shows the output buffer circuitry 200. The output buffer circuitry 200 is actuated by applying a power supply voltage equal to or higher than the withstand voltage of an internal transistor from outside. The output buffer circuitry 200 includes inverters 201 and 202, level shifters 203 and 204, N-type transistors NM1 through NM3, and p-type transistors PM1 through PM3. In this example, the voltage of the logic power supply VDD is 3V, the voltage of the positive power supply VGH is +15V, the voltage of the negative power supply VGL is −15V, and GND voltage is 0V.

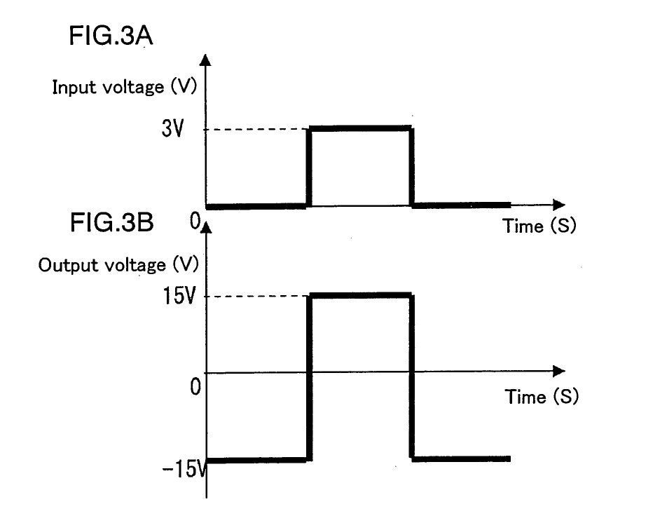

FIG. 3A shows a voltage of a signal to be input to the input terminal portion IN. FIG. 3B shows a voltage of a signal to be output from the output terminal portion OUT. To the input terminal portion IN, a signal of 3V which has an amplification as shown in FIG. 3A is input from a logic circuit in a preceding stage (not shown).

When the voltage at the input terminal portion IN is GND voltage (0V), voltage at nodes 2 and 4 becomes 3V, voltage at a node 3 becomes +15V, and voltage at a node 5 becomes 3V. In such a state, the transistors PM1, PM2 and PM3 are not conductive. The transistors NM1, NM2, and NM3 become conductive. From the output terminal portion OUT, a signal indicating −15V as shown in FIG. 3B is output.

When the voltage at the input terminal portion IN is 3V, the voltage at the nodes 2, 3, and 4 becomes GND voltage (0V), and the voltage at the node 5 becomes −15V. In such a state, the transistors NM1, NM2, and NM3 are not conductive. The transistors PM1, PM2 and PM3 become conductive. From the output terminal portion OUT, a signal indicating +15V as shown in FIG. 3B is output.

Now, the transistors NM1 and NM2 connected in series are considered as one group. When the voltage at the output terminal portion OUT is +15V, the maximum voltage of 30V (i.e., the power supply voltage VGH—the power supply VGL voltage) may be applied to both ends of the series of the transistors. Thus, if the transistors PM1 and PM2 have the same transistor size, and the transistors NM1 and NM2 have the same transistor size, the withstand voltage required for one transistor becomes (VGH−VGL)/2=15V.

For example, it is assumed that the voltage of the positive power supply VGH is +15V, the voltage of the negative power supply VGL is −15V, and the withstand voltage of all of the diodes D1 through D4 is 20V in the semiconductor device 100 shown in FIG. 1. When the voltage of the output terminal portion OUT is +15V, the voltage at the maximum of 30V is applied to the diodes D3 and D4 which are connected in series. However, the voltage across one diode is 15V. This satisfies the above-mentioned expression (1). When the voltage of the output terminal portion OUT is −15V, the voltage at the maximum of 30V is applied to the diodes D1 and D2 which are connected in series. In this case, the voltage across one diode is also 15V. This also satisfies the expression (1), and thus, there is no problem. When a surge potential of a positive voltage (positive potential noise) is applied to the output terminal portion OUT, the diodes D1 and D2 become conductive and the positive potential noise is absorbed to the power supply VGH. When a surge potential of a negative voltage (negative potential noise) is applied to the output terminal portion OUT, the diodes D3 and D4 become conductive and the negative potential noise is absorbed to the power supply VGL. The diodes D1 through D4 may respectively have a withstand voltage equal to or higher than the withstand voltage of the transistor in the output buffer circuitry 200 so that they can withstand a stronger noise.

As described above, the semiconductor device 100 according to Embodiment 1 of the present invention includes: a plurality of diodes D1 and D2 connected in series between the output terminal portion OUT and the positive power supply VGH; and a plurality of diodes D3 and D4 connected in series between the output terminal portion OUT and the negative power supply VGL. This feature allows the transistor in the output buffer circuitry 200 to be protected from the voltage even when the voltage equal to or higher than the withstand voltage of the transistor in the output buffer circuitry 200 is applied to the output terminal portion OUT from outside. Since the diodes D1 and D2 are connected in series, and diodes D3 and D4 are also connected in series, the diodes can sufficiently work as the protection section even when the voltage equal to or higher than the withstand voltage of one diode is applied to the output terminal portion OUT from outside.

### Embodiment 2

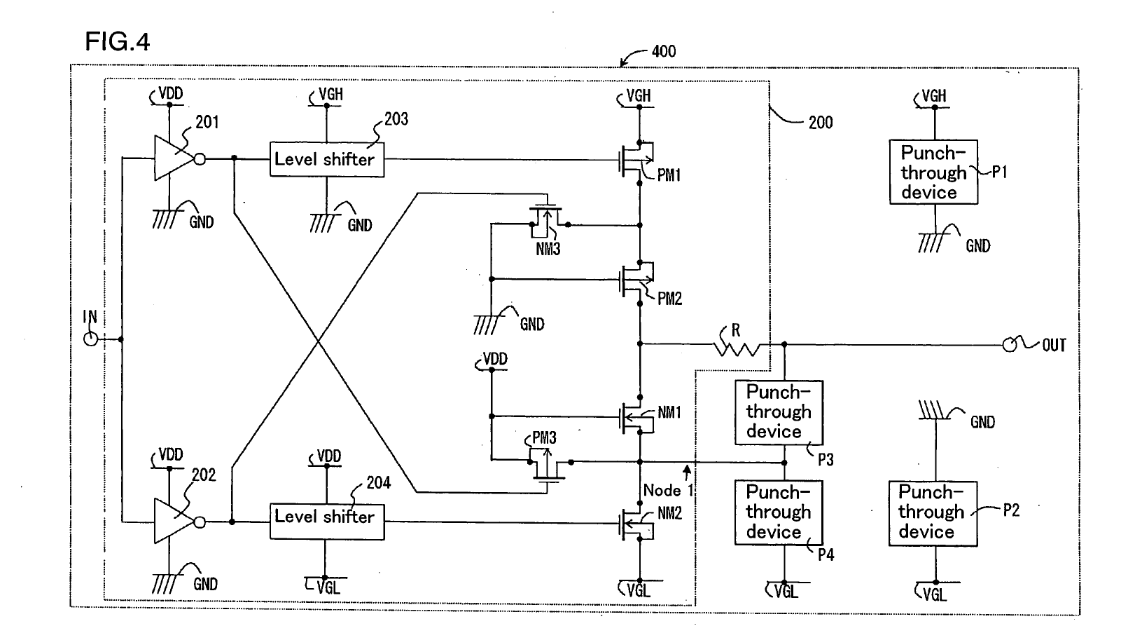

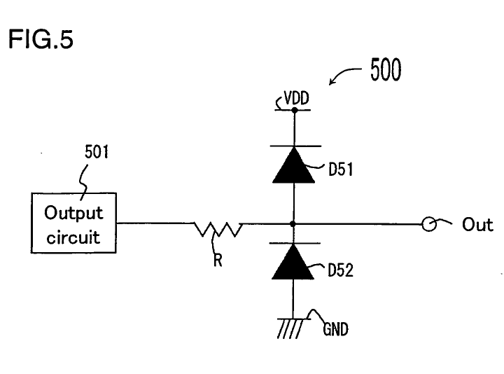

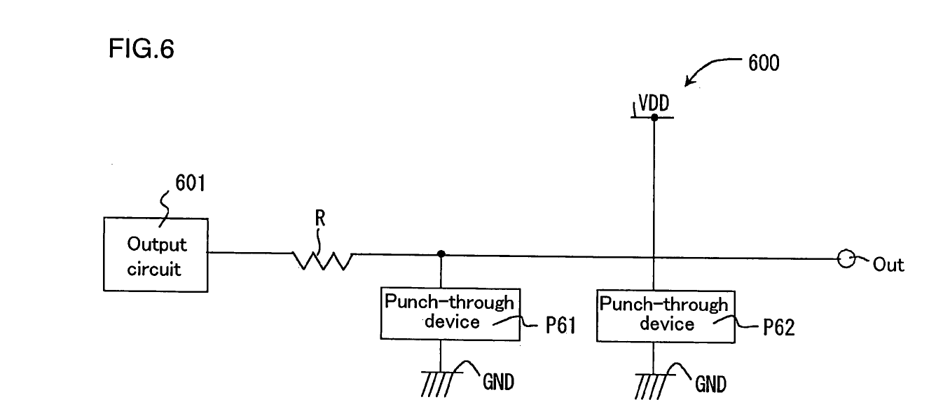

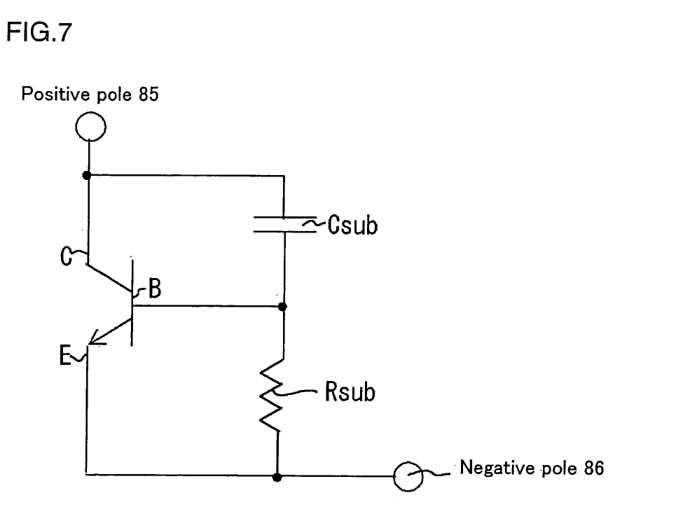

FIG. 4 shows a semiconductor device 400 according to Embodiment 2 of the present invention.

The semiconductor device 400 includes an output buffer circuitry 200, an input terminal portion IN, an output terminal portion OUT, and punch-through devices P1 through P4. The components included in the semiconductor device 400 which are the same as the components included in the semiconductor device 100 shown in FIG. 1 are denoted by the same reference numerals, and the descriptions thereof are omitted.

In Embodiment 2 of the present invention, the output buffer circuitry 200 is also connected to an external circuitry 250 (FIG. 1) via a protection resistance R and the output terminal portion OUT.

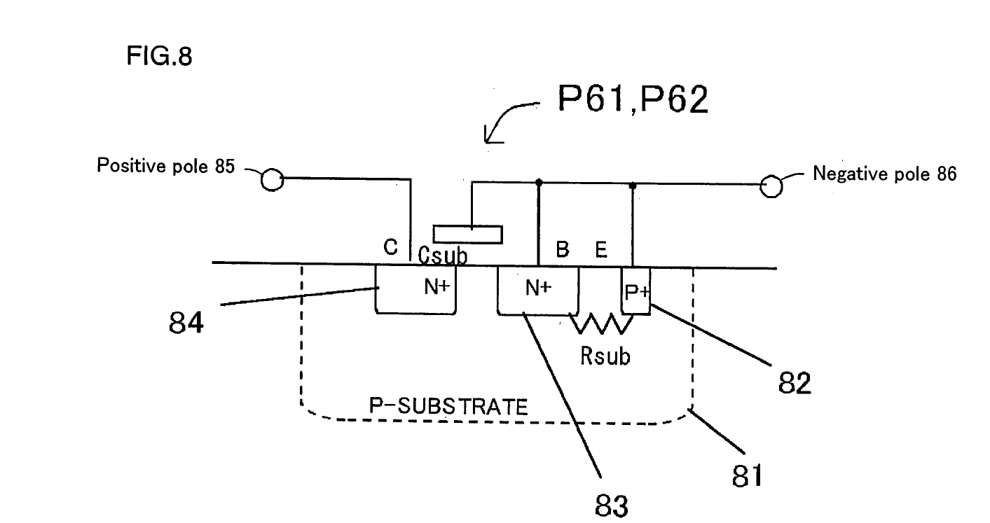

The punch-through devices P1 and P2 are connected in series between the positive power supply VGH and the negative power supply VGL. The punch-through devices P3 and P4 are connected in series between the negative power supply VGL and the output terminal portion OUT. The negative power supply VGL functions as a voltage application section where a negative voltage is applied. The structures of the punch-through devices P1 through P4 are similar to those of the punch-through devices P61 and P62 shown in FIG. 8.

The punch-through devices P1 through P4 function as protection sections for protecting transistors from a positive potential noise and a negative potential noise. In this embodiment, a plurality of protection sections are collectively referred to as a protection circuitry.

The predetermined voltage to be applied to the external circuitry 250 is a voltage such that, when the predetermined voltage is applied to a transistor included in the output buffer circuitry 200 (for example, a transistor NM1 or PM2), a potential difference between the potential at one end (for example, a source electrode) of the transistor and the potential at the other end (for example, a drain electrode) becomes larger than the withstand voltage of the transistor.

A positive pole of the punch-through device P1 is connected to the positive power supply VGH, and a negative pole of the punch-through device P1 is connected to ground GND (a first midpoint potential). A positive pole of the punch-through device P2 is connected to the ground GND, and a negative pole of the punch-through device P2 is connected to the negative power supply VGL. A positive pole of the punch-through device P3 is connected to the output terminal portion OUT, and a negative pole of the punch-through device P3 is connected to a positive pole of the punch-through device P4 and a node 1 (a second midpoint potential). A negative pole of the punch-through device P4 is connected to the negative power supply VGL.

For example, it is assumed that the voltage of the positive power supply VGH is +15V, the voltage of the negative power supply VGL is −15V, the GND voltage is 0V, and the withstand voltage of all of the punch-through devices P1 through P4 is 20V. In this example, the voltage across the punch-through devices P1 through P4 is constant and is 15V. When the voltage of the output terminal portion OUT is +15V, the voltage at the maximum of 30V is applied to the punch-through devices P3 and P4 which are connected in series. However, the voltage across one punch-through device is 15V. This satisfies the above-mentioned expression (1). When a positive voltage (positive potential noise) higher than the voltage of the positive power supply VGH is applied to the output terminal portion OUT, the positive potential noise passes through the punch-through devices P3 and P4 where punch-through phenomena occur and reaches the negative power supply VGL. Then, the positive potential noise passes through the punch-through devices P2 and P1 in a forward bias state, and is absorbed to the power supply VGH. Alternatively, the positive potential noise passes through the transistors NM1, PM2, and PM1 from the punch-through device P3 where a punch-through phenomenon occurs, and is absorbed to the positive power supply VGH.

When a negative voltage (negative potential noise) having an absolute value larger than that of the voltage of the negative power supply VGL is applied to the output terminal portion OUT, the negative potential noise passes through the punch-through devices P4 and P3 in a forward bias state, and is absorbed to the power supply VGL. The punch-through devices P1 through P4 may respectively have a withstand voltage equal to or higher than the withstand voltage of the transistor in the output buffer circuitry 200 so that they can withstand a stronger noise.

As described above, the semiconductor device 400 according to Embodiment 2 of the present invention includes: a plurality of punch-through devices P1 and P2 connected in series between the positive power supply VGH and the voltage application section (in this embodiment, the negative power supply VGL to which a negative voltage is applied); and a plurality of punch-through devices P3 and P4 connected in series between the voltage application section and the output terminal portion OUT. This feature allows the transistor in the output buffer circuitry 200 to be protected from the voltage even when the voltage equal to or higher than the withstand voltage of the transistor in the output buffer circuitry 200 is applied to the output terminal portion OUT from outside. Since the punch-through devices P1 and P2 are connected in series, and punch-through devices P3 and P4 are also connected in series, the punch-through devices can sufficiently work as the protection section even when the voltage equal to or higher than the withstand voltage of one punch-through device is applied to the output terminal portion OUT from outside.

In Embodiment 2 of the present invention, the positive power supply VGH and the negative power supply VGL connected to the punch-through devices P1, P2, and P4 may be interchanged. In such a case, the characteristics of the punch-through devices (such as, types of the regions (P-type, N-type) included in the punch-through devices, polarities of the electrodes, and the like) may be appropriately adjusted so as to conform to the change in the power supply.

In the present invention, the circuitry to which the protection section is not limited to the output buffer circuitry, but may be another circuit.

Further, in the present invention, an additional protection section may be connected to the input terminal portion as necessary.

Moreover, the semiconductor device of the present invention may be implemented on one semiconductor chip, or may be separated and implemented on a plurality chips.

A semiconductor device according to the present invention includes: a plurality of first protection sections connected in series between a terminal portion and a positive power supply; and a plurality of second protection portions connected in series between the terminal portion and a negative power supply. This characteristic allows a transistor in a circuit to be protected even when a voltage equal to or higher than the withstand voltage of the transistor is applied from outside. Since the plurality of first protection sections are connected in series, and the plurality of second protection sections are also connected in series, the protection sections have a sufficient protection function even when a voltage equal to or higher than the withstand voltage of one protection section is applied to the terminal portion.

Further, a semiconductor device according to the present invention includes: a plurality of first protection sections connected in series between one of a positive power supply and a negative supply and a voltage application section to which a first voltage is applied; and a plurality of second protection sections connected in series between the voltage application section and a terminal portion. This characteristic allows a transistor in a circuit to be protected even when a voltage equal to or higher than the withstand voltage of the transistor is applied from outside. Since the plurality of first protection sections are connected in series, and the plurality of second protection sections are also connected in series, the protection sections have a sufficient protection function even when a voltage equal to or higher than the withstand voltage of one protection section is applied to the terminal portion.

As described above, the present invention is particularly useful in the field of semiconductor devices including protection sections.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

1. A semiconductor device, comprising:
a first circuitry including a transistor;
a terminal portion for connecting the first circuitry and a second circuitry to which a predetermined voltage is applied;
a plurality of first protection sections connected in series between the terminal portion and a positive power supply; and
a plurality of second protection sections connected in series between the terminal portion and a negative power supply.

2. A semiconductor device according to claim 1, wherein the predetermined voltage is a voltage such that, when it is applied to the transistor, a potential difference between a potential at one end of the transistor and a potential at the other end becomes larger than a withstand voltage of the transistor.

3. A semiconductor device according to claim 1, wherein withstand voltages of the plurality of first protection sections and the plurality of second protection sections are equal to or higher than the withstand voltage of the transistor.

4. A semiconductor device according to claim 1, wherein the plurality of first protection sections and the plurality of second protection sections are respectively diodes.

5. A semiconductor device according to claim 1, wherein the first circuitry is an output buffer circuitry.

6. A semiconductor device, comprising:
a first circuitry including a transistor;
a terminal portion for connecting the first circuitry and a second circuitry to which a predetermined voltage is applied;
a plurality of first protection sections connected in series between one of a positive power supply and a negative power supply and a voltage application section to which a first voltage is applied; and
a plurality of second protection sections connected in series between the voltage application section and the terminal portion.

7. A semiconductor device according to claim 6, wherein the voltage application section is the other of the positive power supply and the negative power supply.

8. A semiconductor device according to claim 6, wherein the predetermined voltage is a voltage such that, when it is applied to the transistor, a potential difference between a potential at one end of the transistor and a potential at the other end becomes larger than a withstand voltage of the transistor.

9. A semiconductor device according to claim 6, wherein withstand voltages of the plurality of first protection sections and the plurality of second protection sections are equal to or higher than the withstand voltage of the transistor.

10. A semiconductor device according to claim 6, wherein the plurality of first protection sections and the plurality of second protection sections are respectively punch-through devices.

11. A semiconductor device according to claim 6, wherein the first circuitry is an output buffer circuitry.
